(19) United States
(12) Patent Application Publication
(10) Pub. No.: US 2010/0158517 A1
(43) Pub. Date: Jun. 24, 2010

(54) METHOD AND APPARATUS FOR LOSSLESS SIGNAL HANDOVER

(75) Inventor: Raymond G. Bahr, Carlisle, MA (US)

Correspondence Address: LANDO & ANASTASI, LLP;R2013, ONE MAIN STREET, SUITE 1100, CAMBRIDGE, MA, 02142, US

(73) Assignee: RAYTHEON COMPANY, Waltham, MA (US)

(21) Appl. No.: 12/343,160

(22) Filed: Dec. 23, 2008

(51) Int. Cl. H04J 14/00

(52) U.S. Cl. 398/45

(57) ABSTRACT

An optical communication system and method for performing signal handover from one aperture/antenna in the optical communication system to another. In one example, the system includes optical signal processing apparatus that determines a quality metric of the signals received by each aperture, and a frame alignment detection apparatus that detects a frame alignment signal (FAS) in the data stream of at least one of the received optical signals. Based on detection of the FAS and the quality metric, handover is performed from one aperture (e.g., one receiving a signal with a worsening quality metric) to another aperture that is receiving a signal with an improving quality metric.

### BACKGROUND

1. Field of Invention

The present invention relates generally to communication systems and, more particularly, to methods and apparatuses for handing off signals in an optical communication system.

2. Discussion of Related Art

In order for a laser communications link to be closed, there must be an unobstructed view of the receiver and/or transmitter by both end points of the link. If there is only one aperture, link outages will result due to motion of the airborne platform relative to receiver and/or transmitter. Accordingly, in an airborne laser-based communication system, it is necessary for the airborne platform to have multiple apertures so as to be able to maintain a communication link during attitude shifts of the platform. However, shifting from one active aperture to another as the platform position changes relative to the other end point can easily cause a loss of data due to the time and processing necessary to detect the start of a new block of data. Thus, even with multiple apertures, there is still a need to coordinate the data streams from the various apertures in order to prevent such data loss.

### SUMMARY OF INVENTION

Aspects and embodiments are directed to methods and apparatus to provide a lossless handover between different active apertures in a mobile optical communication system. In one example, aspects of the system and methods discussed herein may provide a practical implementation of laser communication on aircraft, while minimizing the protrusion of the laser device beyond the aircraft skin and the size of the skin opening. At least some embodiments of may have the potential of satisfying customer requirements with low cost and risk.

One embodiment is directed to a method of performing a handoff of a first optical signal received at a first aperture to a second optical received at a second aperture. The method may comprise measuring a signal quality metric of the first optical signal received by the first aperture, measuring the signal quality metric of the second optical signal received by the second aperture, detecting a frame alignment signal in a second data stream corresponding to the second optical signal, determining that the signal quality metric of the second optical signal is improving with time, and forwarding the second data stream to receiver electronics for processing. In one example, the method further comprises forwarding a first data stream corresponding to the first optical signal to the receiver electronics for processing, and based on the determining act, switching from forwarding the first data stream to forwarding the second data stream. Switching may be performed on a frame boundary of the second data steam identified using the detected frame alignment signal in the second data stream. In another example, measuring the signal quality metric of the first and second optical signals includes measuring a power level of the first and second optical signals. Determining that the quality metric of the second optical signal is improving with time may include determining that the power level of the second optical signal is increasing with time.

According to another embodiment, a method of selecting a signal from an aperture in an optical communication system comprises acts of performing signal quality processing on received optical signals from at least two apertures, detecting a frame alignment signal in at least one of the received optical signals, selecting one of the at least two apertures based on detection of the frame alignment signal and a result of the signal quality processing, and forwarding a data stream from the selected one aperture to receiver electronics for processing. In one example, performing the signal quality processing includes measuring a power level of each of the received optical signals. In another example, selecting one of the at least two apertures includes identifying a first aperture of the at least two apertures receiving an optical signal with an increasing power level. In another example, detecting the frame alignment signal in at least one of the received optical signals includes detecting the frame alignment signal in the received optical signal from the first aperture. According to another example, selecting one of the at least two apertures includes selecting the first aperture, and forwarding the data stream may include actuating a data switch to forward the data stream from the first aperture to the receiver electronics.

According to another embodiment, an optical communication system comprises a plurality of apertures configured to receive an optical signal, an optical processing apparatus configured to receive the optical signal from at least two of the plurality of apertures, to perform signal quality processing on the optical signals and to output at least two data streams corresponding to the optical signal received from the at least two apertures, a frame alignment detection apparatus coupled to the optical processing apparatus to receive the at least two data streams and configured to detect a frame alignment signal in at least one data stream, a data switch configured to receive the at least two data streams, a processor coupled to the data switch and to the optical processing apparatus, and a MODEM coupled to the data switch, wherein the processor is configured to control the data switch to select one of the at least two data streams based on the signal quality processing performed by the optical processing apparatus and to forward the selected data stream to the MODEM.

In one example, the optical communication system further comprises switching logic coupled to the data switch and to the processor and configured to provide an interface between the processor and the data switch; wherein the processor is configured to provide a control signal to the switching logic and the switching logic is configured to actuate the data switch, based on the control signal, to forward the selected data stream to the MODEM. In one example, the switching logic is coupled to the frame alignment detection apparatus and configured to actuate the data switch to forward the selected data stream to the MODEM on a frame boundary of the data selected stream. The optical processing apparatus may include a power detector configured to measure a power level of the optical signals received by the at least two apertures. In one example, the processor is configured to select one of the at least two data streams based on the corresponding optical signal having an increasing power level. In another example, the optical communication system is an airborne laser-based optical communication system.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment in any manner consistent with the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of one example of a portion of an optical communication system according to aspects of the invention;

FIG. 2 is a flow diagram illustrating one example of a method according to aspects of the invention;

FIG. 3 is a graph illustrating various plots of received optical power as a function of time to demonstrate an example of the handoff from one receive aperture to another in accordance with aspects of the invention; and

FIG. 4 is a flow diagram illustrating one example of a timeline for an example of a handover procedure in accordance with aspects of the invention.

### DETAILED DESCRIPTION

Aspects and embodiments are directed to methods and apparatus for accomplishing handover from one active aperture to another in a mobile optical communication system. In one example, the mobile optical communication system is an airborne laser-based communication system. However, it is to be appreciated that the invention is not limited to laser-based communication systems nor to airborne systems, and may be used with any type of optical (or other) communication system located on any type of mobile platform, that may require or benefit from the handover techniques discussed herein. A lossless handover may be currently preferred over simply using the protocols to detect and manage dropped packets due to potential high data rates and long latencies between the receiver and the transmitter. Accordingly, at least some aspects and embodiments are directed to providing such a lossless handover from one aperture to another.

It is to be appreciated that embodiments of the methods and apparatus discussed herein are not limited in application to the details of construction and the arrangement of components set forth in the following description or illustrated in the accompanying figures. The methods and apparatus are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, and upper and lower are intended for convenience of description, not to limit the present systems and methods or their components to any one positional or spatial orientation.

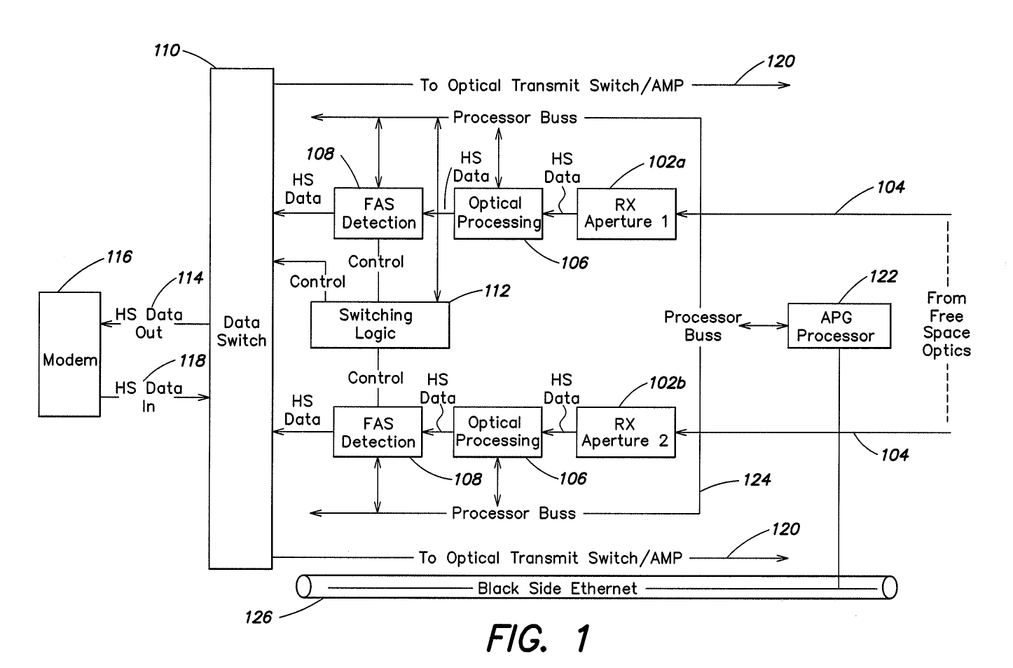

Referring to FIG. 1, there is illustrated one example of an optical two-way communication system. The system includes a plurality of receiver apertures, including a first aperture 102a and a second aperture 102b which receive an optical signal 104. In one embodiment, the system is configured such that adjacent apertures 102a, 102b will have overlapping fields of regard (FOR). It is to be appreciated that although or simplicity and clarity only two apertures and associated data flows are shown in FIG. 1, the system may support N apertures and thus N independent and simultaneous data flows, one from each of the N apertures. According to one embodiment, the handover sequence from the first aperture 102a to the second aperture 102b is as follows. At a given point in time, the first aperture 102a will have an active communication link. As the mobile platform rotates or otherwise moves with respect to the source of the optical signal 104, the second aperture 102b will begin receiving the same data stream delayed in time. As the mobile platform continues to rotate, the first aperture 102a will lose the link, but the second aperture 102b will now support this link. Examples of methods and apparatus for achieving a lossless handover from aperture 102a to aperture 102b are discussed below.

According to one embodiment, given a data stream that has a well known frame boundary established by the frame alignment bit stream (FAS), and given convolutional interleavers at the source of the optical signal and in the MODEM 116 that preserve the position in time and space of the FAS bits, the optical system of FIG. 1 may implement a processing stage that detects the FAS bits of the interleaved frame without needing to de-interleave the entire frame. With this detection of the FAS in the data stream, according to one embodiment, the aperture handover can be performed on a basis of a quality metric (e.g., signal power or signal-to-noise ratio) of the received optical signal at one or more apertures and the presence of the detected FAS bits prior to the complete demodulation of the received signal at the MODEM 116, as discussed further below. An advantage of such a handover technique is that a single MODEM 116 may support N apertures for handover. For example, because the handover can be performed prior to complete demodulation of the data stream, a dedicated MODEM is not required for each aperture.

Still referring to FIG. 1, in one embodiment, the optical signal received by the receiver apertures 102a, 102b is transmitted to an optical processing apparatus/block 106 that performs the signal processing convert the received optical signal 104 to an electrical signal. As discussed further below, the optical processing block 106 may also implement some signal quality processing on the received optical signal to measure or determine the quality metric which may be used for the handover from one aperture to another. This electrical signal, also referred to as the data stream, is passed to a FAS detection apparatus/block 108 that is configured to locate the frame alignment signal (FAS) in the incoming data stream, as discussed further below. The outputs from the FAS detection blocks 108, referred to as “HS data streams,” are provided to a data switch 110. As discussed further below, under the control of switching logic 112, the data switch passes one of the HS data streams from one of the FAS detection blocks 108, as the signal “HS Data Out” 114 to the MODEM 116 and the remaining receiver electronics (not shown) of the optical communication system.

On the transmit side, the data switch 10 passes a signal, “HS Data In” 118 from the MODEM 116 to optical transmit circuitry (not shown), such as an optical switch and/or amplifier, for transmission to the other end point of the communication link. The system may further comprise an aperture processing group (APG) processor that communicates with various components of the system, such as the optical processing block 106, switching logic 112 and FAS detection block 108 via a processor buss 124. In one example, the APG processor is a general purpose processor (GPP), or a GPP core residing on a field programmable gate array (FPGA), that provides control signals to the various components. The processor buss 124 provides a local signal/control plane for the electrical components of the system. The system may also include an Ethernet 126 that provides a control plane between the APG processor 122 and other components of the system.

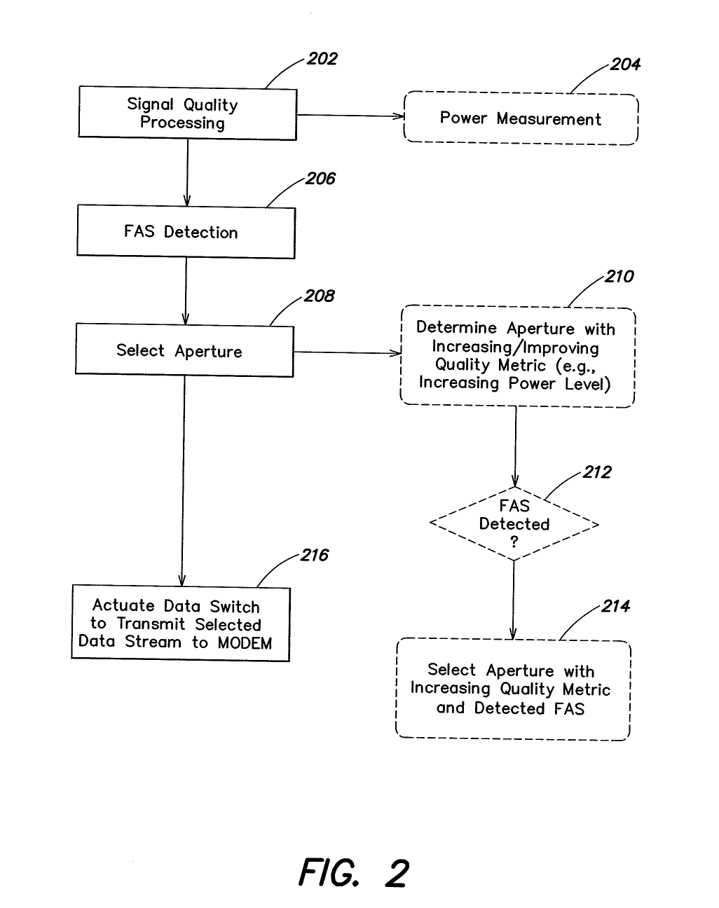

Referring to FIG. 2, there is illustrated a flow diagram of one example of a handover procedure. In step 202, signal quality processing is performed on the incoming optical signal 104. In one example, this signal quality processing includes signal-to-noise measurements and/or measuring the power level (e.g., average, RMS or peak power) of the received signal (step 204). Accordingly, in one example, the system of FIG. 1 includes a power detector to measure the signal power of the optical signal received at each aperture. This power detector may be included in the optical processing block 106 or may be a separate block (not shown in FIG. 1), in the data flow for each aperture. The power detector may communicate with the APG processor 122 (for example, via the processor buss 124) to provide the APG processor with an indication of the power level of the signal received at each aperture. Thus, in one example, the power measurement is used to describe the received signal quality and to evaluate it over time. However, it is to be appreciated that parameters and characteristics of the signal other than a power measurement may be used to describe the signal quality and to select a particular data flow (and associated aperture). For example, the bit error rate (BER) and/or signal-to-noise ration may be used as measures of signal quality.

Still referring to FIG. 2, in step 206, the incoming HS data stream from the optical processing block 106 is analyzed by the FAS detection block 108. As discussed above, according to one embodiment, the data stream has a well defined frame sequence which is not obstructed by interleaving or other coding methods, so as to enable detection of the FAS without requiring complete demodulation of the data stream. In one example, the system supports Optical Transport Network (OTN) framing, with a convolutional interleaver that preserves the frame alignment signal (FAS) bit pattern. In this example, the HS data represents the OTN data streams being processed. However, it to be appreciated that other types of framing, other than OTN, may also be used. In one example, FAS detection includes a pattern matching function implemented, for example, in a field programmable gate array (FPGA) or application specific integrated circuit (ASIC). In one example, the pattern matching function duplicates the functionality (rules of matching) found in off-the-shelf framing products for the framing used for the data stream. For example, as discussed above, the data stream may use an OTN-1 frame and the FAS detection block 108 may thus be configured to implement pattern matching rules for OTN-1 framing. In another example where the data stream uses a non-standard framing, the pattern matching functionality of the FAS detection lock 108 is designed to support the defined framing protocol.

According to one embodiment, the OTN frame alignment signal (FAS) is a 12 byte field containing a well known bit pattern indicating the start of a frame. The FAS detection block 108 may use pattern matching techniques to locate the FAS in the incoming HS data stream. Thus, step 206 may include analyzing the HS data stream to locate the FAS and thereby locate the start of a frame in the data stream. It is to be appreciated that although the signal quality processing step 202 and optional power measurement step 204 are illustrated occurring prior to the FAS detection step 206 in the flow diagram of FIG. 2, the invention is not so limited and the FAS detection step 206 may be performed prior to, simultaneously with, or after the signal quality processing step 202 and/or power measurement step 204.

Still referring to FIG. 2, in a next step 208 the system may select the data stream from one aperture 102a or 102b to be transmitted to the MODEM 116 as the HS Data Out signal 114 based on the results of the signal quality processing step 202 and FAS detection step 206. As discussed above, in one embodiment, the optical processing block 106, FAS detection block 108 and other circuitry (e.g., the power detector if implemented separately from the optical detection block 106) are in communication with the APG processor 122 via the processor buss 124. Accordingly, the results of the signal quality processing step 202 and FAS detection step 206 may be provided, by the corresponding electronics, to the APG processor 122 which may perform the analysis to select an appropriate aperture. In one example, in which the power level of the received signal is used as the quality metric, the power detector may periodically or continuously measure the received power level at two or more apertures and provide the power measurements to the APG processor 122. The APG processor may analyze the power measurements to determine which aperture has an increasing power level (step 210), indicating that the mobile platform may be moving such that that aperture is gaining the communication link. The APG processor may also verify that the FAS has been detected in the data stream from the aperture with the growing power level (step 212). At this point, the aperture with the growing power level and detected FAS pattern is selected (step 214) and its data stream will be switched (step 216) on a frame boundary (using the FAS) to the MODEM 116 for further processing. Similarly, in examples where a signal quality metric other than the signal power level is used (e.g., signal-to-noise ratio or bit error rate), the APG processor may determine which aperture has a signal with an improving quality metric, and verify that the FAS is detected in that data stream, and select the data stream from that aperture (step 214).

According to one embodiment, the data stream from the aperture with the improving signal quality metric (e.g., increasing power level) is selected by controlling the switching logic 112 to control the data switch 110 to switch the HS data stream from the selected aperture 102a or 102b through to the MODEM 116 (step 216). As discussed above, the switching logic 112 may be controlled by the APG processor 122 via the processor buss 124. In one example, the switching logic may aggregate control signals received from the FAS detection blocks 108 and present these control signals to the APG processor 122. The control signals may be used to facilitate switching to a selected data stream on a frame boundary. In addition, the switching logic 112 may provide an interface between the APG processor 122 and the data switch 110. In one example, the data switch 110 is a switch or buffer capable of buffering multiple OTN packets or frames per input data stream (channel), and selecting and switching between multiple input data streams under the control of the switching logic 112. In particular, the data switch may be configured to receive and buffer the N data streams from the N apertures in the system and to switch (under processor control) one of N input buffer streams to the output as the HS Data Out signal 114. In one example, the data switch supports data rates in a range of about 2.5 Gigabits per second (Gbps) to about 10 Gbps. In one embodiment, the FAS detection block 108, switching logic 112 and data switch 110 are implemented a combination of an FPGA and a GPP, using industry standard interconnects, such as, for example, SPI 4 or an equivalent thereof. However, it is to be appreciated that many other implementations are possible, as would be recognized by those skilled in the art given the benefit of this disclosure.

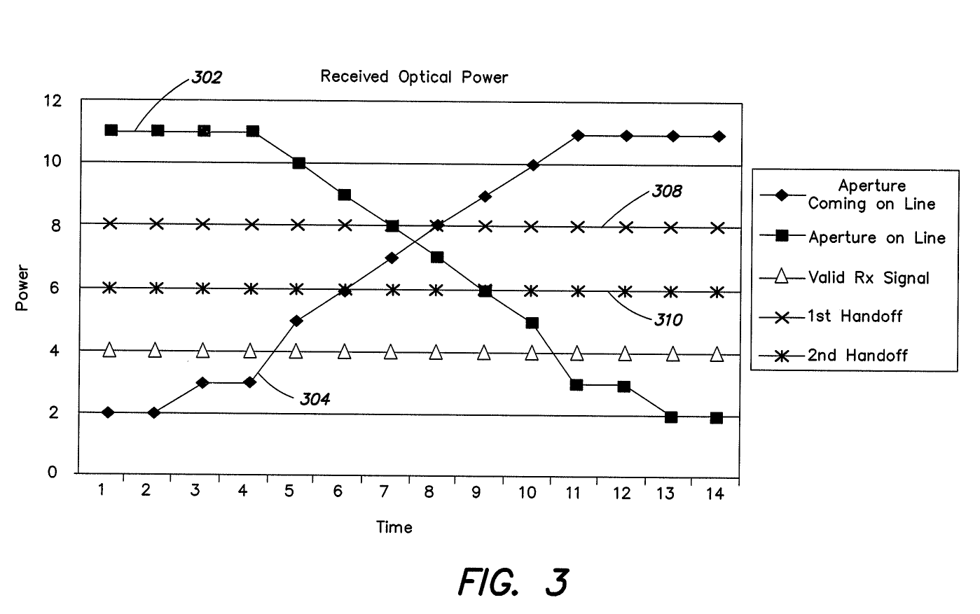

Referring to FIG. 3, there is illustrated an example of a handover procedure from one aperture to another using received optical power to determine when the handoff occurs, as discussed above. Line 302 represents the power level of the optical signal received at a first aperture, for example aperture 102a, as a function of time. At a first instant in time (e.g., t=1), this aperture 102a is “on line” and receiving a valid signal. At the same time, a second aperture, for example, aperture 102b is “off line” and will be receiving noise, as indicated by line 304. As time progresses, due the movement of the mobile platform, the second aperture 102b will be coming on line and will start receiving the optical signal, as indicated by line 304. Line 306 represents a “valid received signal,” meaning the threshold above which an optical signal with sufficient power is detected. In the illustrated example, first and second handoff lines 308, 310, respectively demarcate a region where, upon entering, the aperture with the decreasing received signal (represented by line 302) will hand off to the aperture with the increasing received signal represented by line 304. Two handoff lines 308, 310 may be used such that this region will provide a hysteresis to prevent the handover process from oscillating from one aperture to another. In one example, this hysteresis accounts for boundary conditions where the mobile platform, and thus also the apertures, are not moving much.

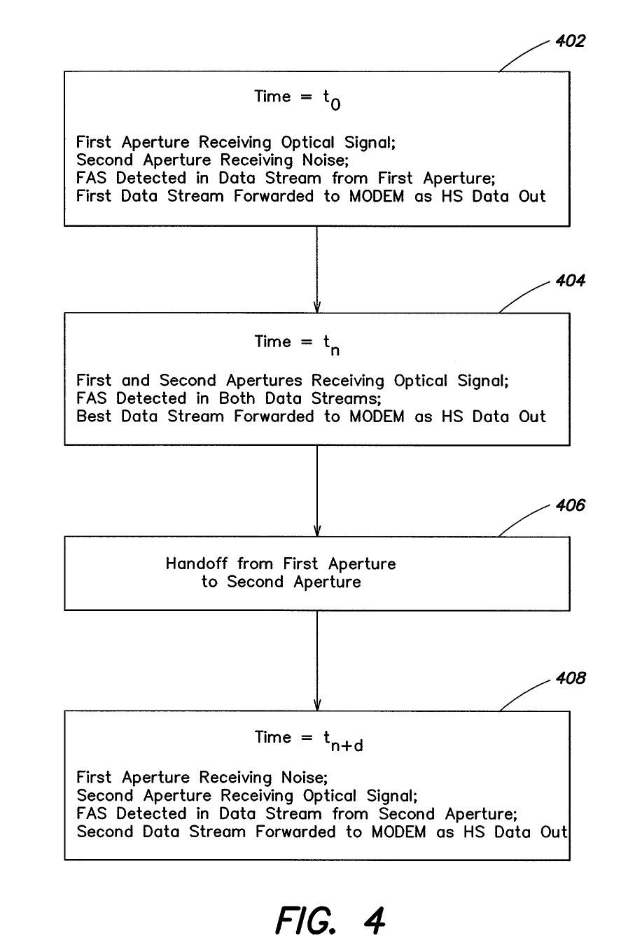

Referring to FIG. 4, there is illustrated a flow diagram showing an example of a timeline for an example of the handover procedure discussed above. At time t₀ (block 402), the first aperture 102a will be receiving the optical signal 104 and the second aperture 102b will be receiving noise. As discussed above, in one example, the optical signal includes an OTN framed data stream. At time t₀ the FAS detection block 108 will be detecting a FAS pattern in the data stream from aperture 102a, and the switching logic 112 and data switch will be forwarding the HS data stream from aperture 102a for processing by the MODEM 116.

At time tₙ (block 404), the motion of the mobile platform will be such that both aperture 102a and aperture 102b will be receiving the same OTN framed stream, delayed in time. The FAS detection block 108 will be detecting a FAS pattern in the data stream from aperture 102a as well as in the data stream from aperture 102b. According to one embodiment, the switching logic 112 and data switch 110 will forward the data stream from the aperture (102a or 102b) with the best signal as defined by the chosen quality metric, for example, the received power levels of the signals from the two apertures.

Still referring to FIG. 4, at time t_{n+d}, where d is some time delta (block 408), the motion of the mobile platform will have been such that aperture 102a no longer has the source of the optical signal (e.g., a satellite, ground station, or other signal source) in its field of regard and therefore, is no longer receiving a valid optical signal. For example, this would be the case at time 12-14 in FIG. 3, as illustrated by line 302. At this time, the handoff from aperture 102a to aperture 102b will occur, or will have occurred (block 406), and the switching logic 112 and data switch 110 will forward the data stream from aperture 102b for processing by the modem. In one example, the data (HS Data Out 114) is presented to the MODEM 116 in “a packet at a time” manner. This may affect latency, but at currently expected data rates, the effect may be minimal.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method of performing a handoff of a first optical signal received at a first aperture to a second optical received at a second aperture, the method comprising:
measuring a signal quality metric of the first optical signal received by the first aperture;
measuring the signal quality metric of the second optical signal received by the second aperture;
detecting a frame alignment signal in a second data stream corresponding to the second optical signal;
determining that the signal quality metric of the second optical signal is improving with time; and
forwarding the second data stream to receiver electronics for processing.

2. The method as claimed in claim 1, further comprising:
forwarding a first data stream corresponding to the first optical signal to the receiver electronics for processing; and
based on the determining act, switching from forwarding the first data stream to forwarding the second data stream.

3. The method as claimed in claim 2, wherein switching is performed on a frame boundary of the second data steam identified using the detected frame alignment signal in the second data stream.

4. The method as claimed in claim 1, wherein measuring the signal quality metric of the first and second optical signals includes measuring a power level of the first and second optical signals.

5. The method as claimed in claim 4, wherein determining that the quality metric of the second optical signal is improving with time includes determining that the power level of the second optical signal is increasing with time.

6. A method of selecting a signal from an aperture in an optical communication system, the method comprising:
performing signal quality processing on received optical signals from at least two apertures;
detecting a frame alignment signal in at least one of the received optical signals;
selecting one of the at least two apertures based on detection of the frame alignment signal and a result of the signal quality processing; and
forwarding a data stream from the selected one aperture to receiver electronics for processing.

7. The method as claimed in claim 6, wherein performing the signal quality processing includes measuring a power level of each of the received optical signals.

8. The method as claimed in claim 7, wherein selecting one of the at least two apertures includes identifying a first aperture of the at least two apertures receiving an optical signal with an increasing power level.

9. The method as claimed in claim 8, wherein detecting the frame alignment signal in at least one of the received optical signals includes detecting the frame alignment signal in the received optical signal from the first aperture.

10. The method as claimed in claim 9, wherein selecting one of the at least two apertures includes selecting the first aperture.

11. The method as claimed in claim 10, wherein forwarding the data stream includes actuating a data switch to forward the data stream from the first aperture to the receiver electronics.

12. An optical communication system comprising:
a plurality of apertures configured to receive an optical signal;
an optical processing apparatus configured to receive the optical signal from at least two of the plurality of apertures, to perform signal quality processing on the optical signals and to output at least two data streams corresponding to the optical signal received from the at least two apertures;
a frame alignment detection apparatus coupled to the optical processing apparatus to receive the at least two data streams and configured to detect a frame alignment signal in at least one data stream;
a data switch configured to receive the at least two data streams;
a processor coupled to the data switch and to the optical processing apparatus; and
a MODEM coupled to the data switch;
wherein the processor is configured to control the data switch to select one of the at least two data streams based on the signal quality processing performed by the optical processing apparatus and to forward the selected data stream to the MODEM.

13. The optical communication system as claimed in claim 12, further comprising switching logic coupled to the data switch and to the processor and configured to provide an interface between the processor and the data switch; wherein the processor is configured to provide a control signal to the switching logic and the switching logic is configured to actuate the data switch, based on the control signal, to forward the selected data stream to the MODEM.

14. The optical communication system as claimed in claim 13, wherein the switching logic is coupled to the frame alignment detection apparatus and configured to actuate the data switch to forward the selected data stream to the MODEM on a frame boundary of the data selected stream.

15. The optical communication system as claimed in claim 12, wherein the optical processing apparatus includes a power detector configured to measure a power level of the optical signals received by the at least two apertures.

16. The optical communication system as claimed in claim 16, wherein the processor is configured to select one of the at least two data streams based on the corresponding optical signal having an increasing power level.

17. The optical communication system as claimed in claim 12, wherein the optical communication system is an airborne laser-based optical communication system.
